(19) United States
(12) Patent Application Publication
(10) Pub. No.: US 2008/0012388 A1
(43) Pub. Date: Jan. 17, 2008

(54) Glass Mounting Structure

(75) Inventors: Yuuji Kinoshita, Tokyo (JP); Takeshi Akagawa, Tokyo (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: HINO MOTORS, LTD.

(21) Appl. No.: 11/769,155

(22) Filed: Jun. 27, 2007

(30) Foreign Application Priority Data
Jun. 27, 2006 (JP) 2006-175969

(51) Int. Cl. B60J 1/00

(52) U.S. Cl. 296/201

(57) ABSTRACT

The present invention aims to provide a glass mounting structure that enables a glass to be mounted, preventing the breakage thereof.

A locking member 52 is provided at a glass 13 closing an opening portion 11a in a cab 11, a mounting portion 54 opposed to the locking member 52 is formed at the opening portion 11a, and a locked member 57 is provided for mounting the glass 13 at the opening portion 11a by locking the locking member 52 to the mounting portion 54. The locked member 57 is held by the locking member 52 in the state where the locking member 52 is movable with respect to the mounting portion 54. The locking member 51 is provided at least at either a lower portion inner surface or an upper portion inner surface in a side portion of the windshield glass 13.

### BACKGROUND OF THE INVENTION

1. Field of the Invention

The present invention relates to a glass mounting structure in a cab of a truck.

2. Description of the Related Art

In the prior art, a windshield glass is provided at an opening of a cab front surface of a truck, and a side glass is provided at an upper part of a door which closes a side opening capable of being kept open. There has been disclosed a front structure of a vehicle in which a front corner member extending along a side portion of a windshield glass and a front portion of a side glass is provided between the side portion of the windshield glass and the front portion of the side glass and the width of the front corner member is 40 to 58 mm when viewed by a driver seated in a driver's seat of the vehicle is disclosed (for example, refer to Patent Document 1). In this front structure of a vehicle, the front corner member comprises a front pillar, a door frame, a glass frame and a glass run, and the front pillar is formed in a cylindrical shape by bonding both side portions of a pillar inner panel and both side portions of a pillar outer panel.

The pillar inner panel has a pillar inner body provided along the visual line direction of a driver seated on a driver's seat of a truck, a first front flange formed integrally with the pillar inner body at the front portion of the pillar inner body, and a first rear flange formed integrally with the pillar inner body at the rear portion of the pillar inner body. Also, the pillar outer panel has a pillar outer body provided substantially opposite to the front face of the door frame, a second front flange formed integrally with the pillar outer body at the front portion of the pillar outer body, and a second rear flange formed integrally with the pillar outer body at the rear portion of the pillar outer body. A front overlap portion is formed by bonding the pillar outer surface of the first front flange and the pillar inner surface of the second front flange. Also, an adhesive is filled in a gap between the front overlap portion and the inner surface of the windshield glass, and the side portion of the windshield glass is mounted to the front pillar by using this adhesive. Moreover, a molding is fitted into the outer periphery portion of the windshield glass in order to improve appearance of the outer periphery portion of the windshield glass.

In the front structure of a vehicle constructed as above, the width of the front corner member is 40 to 58 mm when viewed from a driver seated in a driver's seat of the vehicle. Therefore, when the driver of the vehicle focuses his both eyes to a target outside diagonally right in front of the vehicle in order to turn right at an intersection, for example, the relatively narrow front corner member close to him looks blurred due to parallax, and the target beyond the front corner member is not obstructed by the front corner member and thereby the driver can see a continuous visual field from the front of the vehicle to the right side. As a result, the driver of the vehicle does not have to move his upper body right or left in order to visually check the other side of the front corner member but the driver can surely check the target outside the vehicle visually only by looking straight at the direction of the front corner member by moving only his head.

On the other hand, in order to bond the windshield glass to a front pillar and the like, the windshield is positioned, and in order to prevent the windshield from moving before hardening of the adhesive, the windshield glass is mounted to the opening of the cab at the time of bonding the windshield glass. In this conventional glass mounting structure, as shown in FIG. 10, a bolt 3 is fastened to a glass 1 through a bracket 2 machined in a hat shape, a mounting hole 4a is formed at a front pillar 4 and the like opposed to this bolt, the bolt 3 is inserted into the mounting hole 4a and a nut 6 is screwed so as to bring the glass 1 into close contact with a mounting portion made of the front pillar 3 and the like, so that the glass 3 is mounted.

Patent Document 1

Japanese Unexamined Patent Application Publication No. 2006-96270 (Claim 1, paragraphs [0007], [0008], [0011] to [0013])

However, in case the glass 1 is brought into close contact with the mounting portion made of the front pillar 4 and the like by inserting the bolt 3 fixed to the glass 1 into the mounting hole 4a and screwing the nut 6, i.e. in case the glass 1 and the mounting portion at the front pillar 4 are not in parallel with each other due to a manufacturing error, so that they are inclined and thereby cannot be brought into close contact with each other as shown in FIG. 10, there has been a problem that if the nut 6 is screwed with the bolt 3, the glass 1 to which the bolt 3 is fastened is to be brought into close contact with the mounting portion, which might break the glass 1.

On the other hand, with respect to the front pillar 4 to which the glass 1 is bonded, it is preferable to make the pillar width narrow when it is seen by a driver, since the visual field of the driver is widened, but if the bolt 3 is fixed to the side portion of the windshield glass 1, it becomes necessary to form a mounting portion at the front pillar 4 opposed to the bolt 3, which might lead to a problem that the width of the front pillar 4 seen from the driver is expanded.

It is an object of the present invention to provide a glass mounting structure that enables a glass to be mounted, preventing the breakage thereof even if the glass is not in parallel with a mounting portion of a front pillar.

It is another object of the present invention to provide a glass mounting structure that enables a windshield glass to be mounted to a front pillar without expanding the width of the front pillar when seen by a driver.

### SUMMARY OF THE INVENTION

An invention of claim 1 is, as shown in FIG. 1, improvement of a glass mounting structure in which a locking member 52 is provided at a glass 13 closing an opening portion 11a in a cab 11, a mounting portion 54 opposed to the locking member 52 is formed at the opening portion 11a, and a locked member 57 is provided for mounting the glass 13 at the opening portion 11a by locking the locking member to the mounting portion 54.

The characteristic construction consists in that the locked member 57 is held by the locking member 52 so that the locking member 52 is movable with respect to the mounting member 54.

In the mounting structure described in claim 1, since the locked member 57 is held by the locking member 52 so that the locking member 52 is movable with respect to the mounting portion 54. Therefore, as shown in FIG. 2, for example, even if the glass 13 and the mounting portion 54 are not in parallel with each other due to a manufacturing error so that the glass 13 and the mounting portion 54 are inclined and thereby cannot be brought into close contact with each other, the glass 13 to which the locking member 52 is fastened is not brought into close contact with the mounting portion 54 and not deformed. Thus, breakage of the glass 13 caused by the deformation can be effectively prevented.

An invention of claim 2 is, as shown in FIG. 6, improvement of a glass mounting structure in which locking members 51, 52 are provided at the windshield glass 13 closing the opening portion 11a at a front portion of the cab 11, mounting portions 53, 54 opposed to the locking members 51, 52 are formed at the opening portion 11a, and the windshield glass 13 is mounted at the opening portion 11a by locking the locking members 51, 52 to the mounting portions 53, 54.

The characteristic construction consists in that the locking members 51, 52 are provided at least either of a lower part inner surface or an upper part inner surface in the side portion of the windshield glass 13.

In the glass mounting structure described in claim 2, there is no need to provide a mounting portion at a portion where a center portion in the side portion of the windshield glass 13 is to be bonded. Therefore, the windshield glass 13 can be mounted without expanding the width of the front pillar to which the center portion in the side portion of the windshield glass is to be bonded when seen from a driver seated in a driver's seat.

As mentioned above, according to the present invention, since the locked member is held by the locking member so that the locking member mounted at the glass is movable with respect to the mounting portion on the cab side. Therefore, for example, even if the glass and the mounting portion are not in parallel with each other due to a manufacturing error so that they are inclined and can not be brought into close contact with each other, the glass to which the locking member is fastened is not brought into close contact with the mounting portion or not deformed. Thus, breakage of the glass caused by the deformation can be effectively prevented.

On the other hand, if the locking member for mounting the windshield glass to the cab is provided at least one of the lower part inner surface or the upper part inner surface in the side portion of the windshield glass, there is no need to provide the mounting portion at a portion where the center portion in the side portion of the windshield glass is to be bonded. Therefore, the windshield glass can be mounted without expanding the width of the front pillar to which the center portion in the side portion of the windshield glass is to be bonded when seen from a driver seated in a driver's seat.

### BRIEF DESCRIPTION OF THE DRAWINGS

FIG. 1 is a B-B sectional view illustrating a glass mounting structure of an embodiment in the present invention;

FIG. 2 is a sectional view corresponding to FIG. 1, illustrating a state where a windshield glass and a mounting portion are not in parallel with each other;

FIG. 3 is an A-A sectional view of FIG. 7;

FIG. 4 is a C-C sectional view of FIG. 7;

FIG. 5 is a D-D sectional view of FIG. 4;

FIG. 6 is an exploded perspective view of an essential part of a cab front portion;

FIG. 7 is a perspective view of an essential part of a truck including a front corner member;

FIG. 8 is a sectional view corresponding to FIG. 1, in which a spacer is fitted into a male screw portion;

FIG. 9 is a sectional view corresponding to FIG. 1, in which a stepped nut is used as a locked member;

FIG. 10 is a sectional view corresponding to FIG. 1, illustrating a conventional glass mounting structure.

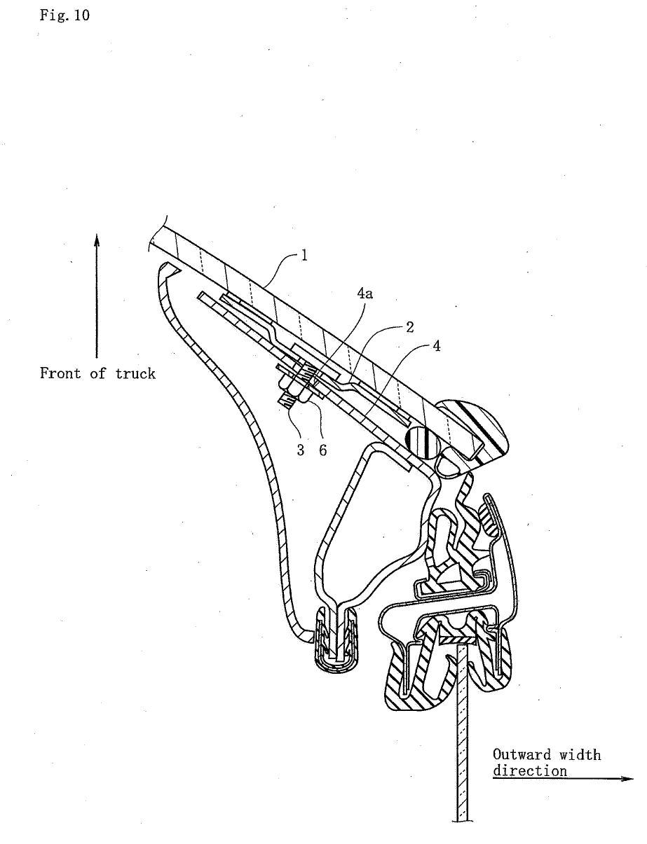

### DETAILED DESCRIPTION OF THE PREFERRED EMBODIMENTS

A best mode for carrying out the present invention will be described referring to the attached drawings.

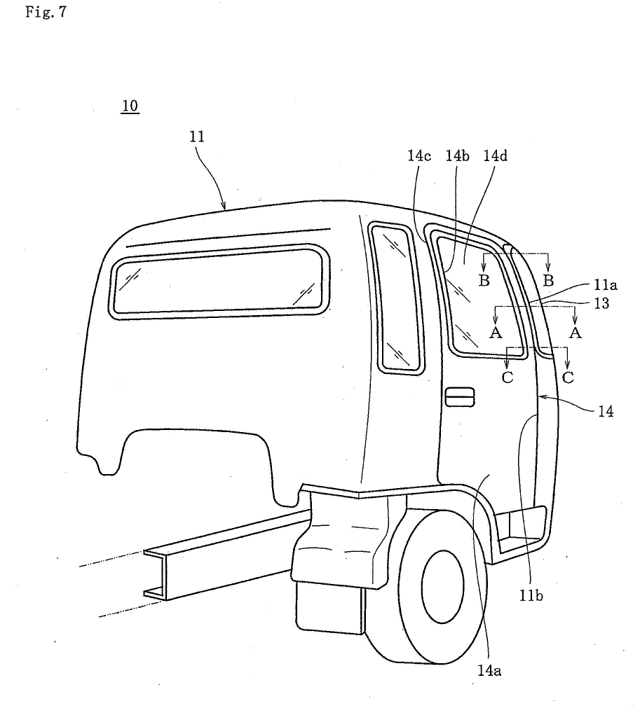

As shown in FIG. 7, a driver's seat, not shown, where a driver is seated, is provided on the right side of a cab 11 of a truck 10, and an opening 11a on the front surface of the cab 11 is closed by a transparent windshield 13. Also, a side opening 11b through which the driver gets on/off the vehicle is provided on the side surface on the driver's seat side of the cab 11, and this side opening 11b is closed by a side door 14, capable of being kept open. The side door 14 comprises a door body 14a, a door frame 14c provided on the upper surface of this door body 14a and formed substantially in the inverted U-shape so as to form a door window 14b, and a transparent side glass 14d closing the door window 14b, capable of being kept open. In this embodiment, description is made using the truck 10 in which the driver's seat is provided on the right side of the cab 11, but the present invention may be applied to a truck 10 in which the driver's seat is provided on the left side of the cab 11.

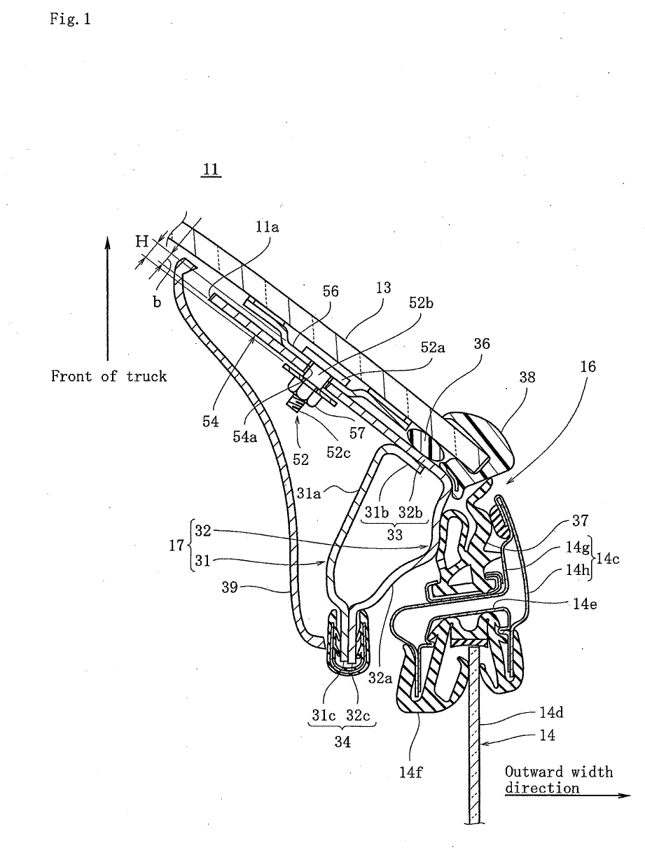

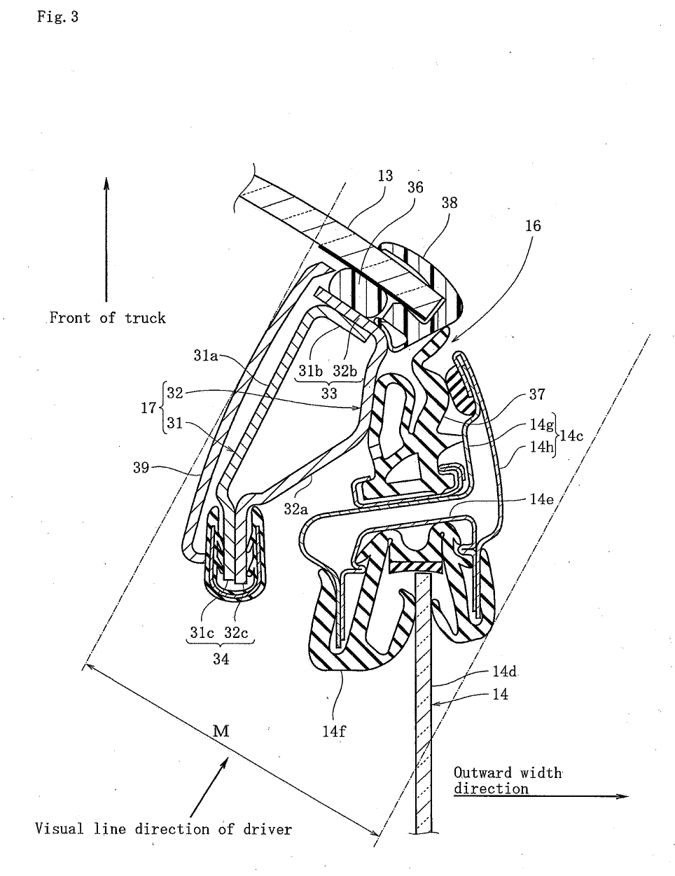

As shown in FIGS. 1 to 4, the front portion of the side glass 14d is surrounded by a glass run 14f, and the glass run 14f is attached to a glass frame 14e in order to hold and guide the side glass 14d. On the other hand, the door frame 14c is formed by bonding a door inner panel 14g and a door outer panel 14h together. And the glass frame 14e is attached by insertion to the door frame 14c, and a front pillar 17 is provided along the right side portion of the windshield glass 13 and the front portion of the side glass 14d between the door frame 14c and the right side portion of the windshield glass 13.

The front pillar 17 is formed in a cylindrical shape extending substantially in the vertical direction, for example, by bonding both side portions of a pillar inner panel 31 and both side portions of a pillar outer panel 32. Thus, the cross section of the front pillar 17 is formed in a closed section. The pillar inner panel 31 comprises a pillar inner body 31a provided along the visual line direction of the driver seated in the driver's seat of the truck 10, a front inner flange 31b formed integrally with the pillar inner body 31a on the front portion of the pillar inner body 31a, and a rear inner flange 31c formed integrally with this pillar inner body 31a on the rear portion of the pillar inner body 31a. The front inner flange 31b is provided inside the cab 11 with a predetermined gap from the inner surface of the windshield glass 13 and extending substantially in parallel with the inner surface of the windshield glass 13 toward the side portion of the windshield glass 13 i.e. it is provided extending in the direction approaching the door frame 14c. Also, the rear inner flange 31c is provided inside the cab 11 with a predetermined gap from the inner surface of the door frame 14c and extending substantially in parallel with the inner surface of the door frame 14c rearward.

On the other hand, the pillar outer panel 32 comprises a pillar outer body 32a provided substantially opposite to the front surface of the door frame 14c, a front outer flange 32b formed integrally with this pillar outer body 32a on the front portion of the pillar outer body 32a, and a rear outer flange 32c formed integrally with this pillar outer body 32a on the rear portion of the pillar outer body 32a. The front outer flange 32b is provided inside the cab 11 with a predetermined gap from the inner surface of the windshield glass 13 and extending substantially in parallel with the inner surface of the windshield glass 13 to the direction opposite to the side portion of the windshield glass 13, i.e., it is provided extending in the direction away from the door frame 14c. The rear outer flange 32c is provided inside the cab 11 with a predetermined gap from the inner surface of the door frame 14c and extending substantially in parallel with the inner surface of the door frame 14c rearward.

A front overlap portion 33 is formed by bonding the pillar outer surface of the front inner flange 31b and the pillar inner surface of the front outer flange 32b, and a rear overlap portion 34 is formed by bonding the pillar inner surface of the rear inner flange 31c and the pillar inner surface of the rear outer flange 32c. In other words, it is preferable that the front overlap portion 33 is formed by bending the pillar inner panel 31 and the pillar outer panel 32 so that the end face of the front inner flange 31b and the end face of the front outer flange 32b are faced in the direction opposite to each other and by bonding the flanges 31b and 32b in this state, and the rear overlap portion 34 is formed by bending the pillar inner panel 31 and the pillar outer panel 32 so that the end face of the rear inner flange 31c and the end face of the rear outer flange 32c are faced in the same direction and bonding the flanges 31c and 32c in this state. Preferably, a laser welding method is used for bonding the front overlap portion 33 and a spot welding method for bonding the rear overlap portion 34.

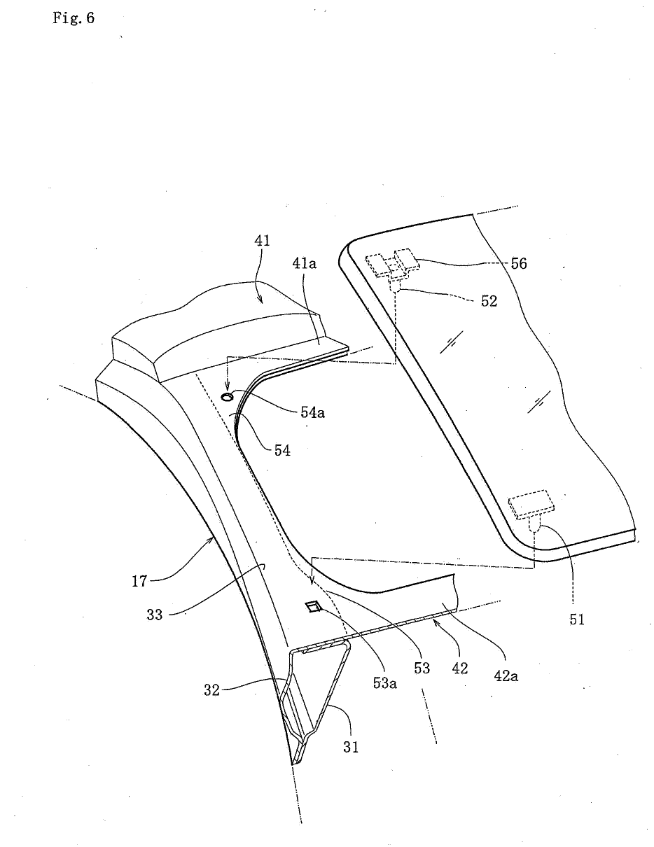

As shown in FIG. 6, a roof panel 41 is connected to an upper portion of the pillar outer panel 32 and a cowl outer panel 42 is connected to a lower portion of the pillar outer panel 32. Though not shown, a roof rail panel is connected to an upper portion of the pillar inner panel 31 through a roof side inner panel, and a cowl inner panel is connected to a lower portion of the pillar inner panel 31. At the front portion of the roof panel 41, an upper outer flange 41a along the upper portion of the windshield glass 13 is provided, while at the upper portion of the cowl outer panel 42, a lower outer flange 42a along the lower portion of the windshield glass 13 is provided. And the inner surfaces of the upper portion and the lower portion of the windshield glass 13 are bonded to the upper outer flange 41a and the lower outer flange 42a, respectively. The inner surface of the side portion of the windshield glass 13 is bonded to the front overlap portion 33 in the front pillar 17.

Returning to FIGS. 1 to 4, the front overlap portion 33 in the front pillar 17 is provided along a glass mounting portion on the inner surface in the side portion of the windshield glass 13. In other words, the side portion inner surface of the windshield glass 13 is mounted on the pillar outer surface of the front overlap portion 33. Specifically, a glass adhesive 36 is filled in a gap between the front overlap portion 33 and the inner surface of the windshield glass 13, and the side portion inner surface of the windshield glass 13 is mounted to the front pillar 17 by using the adhesive 36. Thus, since the adhesion surface of the windshield glass 13 is made in a double structure of the front inner flange 31b and the front outer flange 32b, the rigidity of the adhesion surface of the glass 13 can be improved. And a weather strip 37 is bonded to the door inner panel 14g. The weather strip 37 has its tip end brought into contact with the pillar outer body 32a of the front pillar 17 in the state where the side door 14 is closed and covers the gap between the front pillar 17 and the door frame 14c.

Reference numeral 38 in FIGS. 1 to 4 denotes a molding fitted to the outer periphery portion of the glass 13 in order to improve the appearance of the outer periphery portion of the windshield glass 13. Also, a pillar garnish 38 is provided on the pillar outer surface of the pillar inner body 31a. The front portion of the pillar garnish 39 is provided close to the windshield glass 13, and the rear portion of the pillar garnish 39 is provided so as to be brought into contact with the pillar outer surface of the rear inner flange 31c.

In this truck 10, as mentioned above, the inner surfaces of the upper portion and the lower portion of the windshield glass 13 are bonded to the upper outer flange 41a and the lower outer flange 42a, respectively, and the inner surface of the side portion of the windshield glass 13 is bonded to the front overlap portion 33 in the front pillar 17 so that the periphery of the windshield glass 13 is bonded to the periphery of the front opening 11a. And locking members 51, 52 are provided for preventing the windshield glass 13 from moving while the adhesive 36 for bonding the windshield glass 13 is hardened.

As shown in detail in FIG. 6, the locking members 51, 52 are provided at the windshield glass 13 closing the front opening 11a in the cab 11. This embodiment shows a case where the locking members 51, 52 are provided at both of the lower portion inner surface and the upper portion inner surface in the side portion of the windshield glass 13. On the other hand, mounting portions 53, 54 opposed to the locking members 51, 52 are formed at the opening portion 11a of the cab 11. The mounting portions 53, 54 in this embodiment are formed by extending into the opening 11a the upper portion and the lower portion of the front pillar 17, that is, the upper portion and the lower portion in the front outer flange 32b of the pillar outer panel 32 constituting the front pillar 17. And at the mounting portions 53, 54 formed at the upper portion and the lower portion of the front pillar 17, mounting holes 53a, 54a through which the locking members 51, 52 can be inserted are formed, respectively.

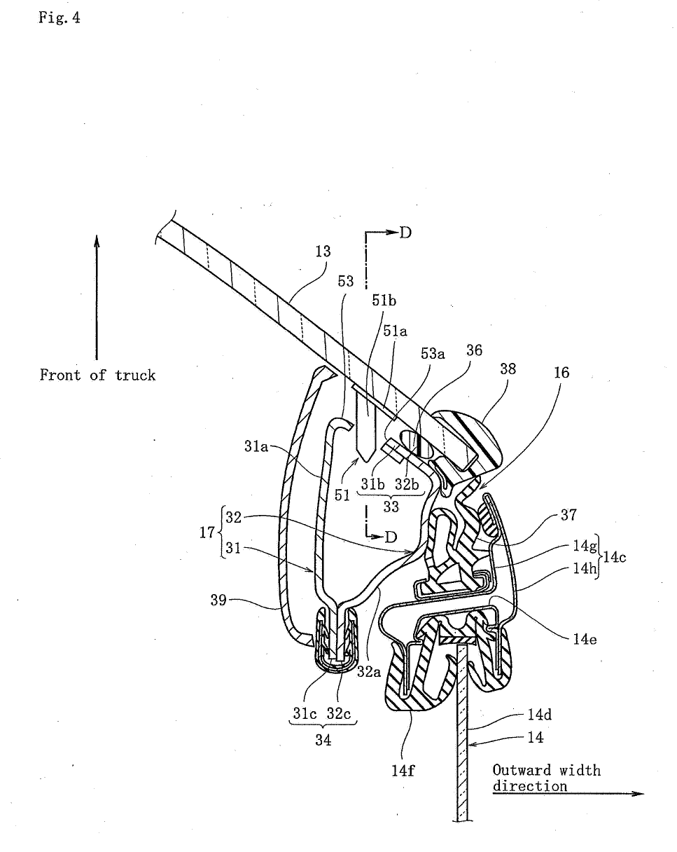

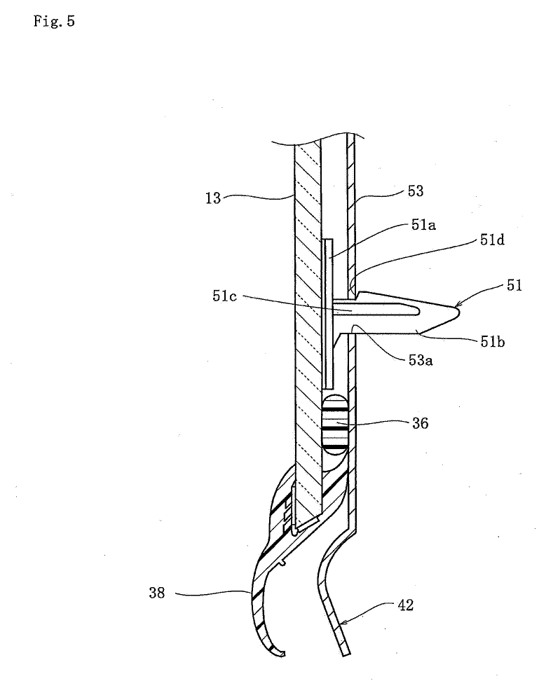

As shown in FIGS. 4 and 5, the locking member 51 provided on the lower portion inner surface in the side portion of the windshield glass 13 is a clip 51 made of a resin and provided with a base portion 51a bonded to the windshield glass 13 and a projection portion 51b installed upright at the base portion 51a and having its tip end oriented toward the opening portion 11a. As shown in FIG. 5 in detail, a cut-out notch 51d locked by a hole edge of the mounting hole 53a is formed at the projection portion 51b in the state that the projection portion 51b is inserted into the mounting hole 53a in the mounting portion 53. Therefore, the projection portion 51b of the clip 51, which is the locking member, is inserted into the mounting hole 53a and the cut-out notch 51d is locked by the hole edge of the mounting hole 53a, so that the lower portion of the windshield glass 13 can be mounted to the lower portion of the opening portion 11a. Here, reference numeral 51c in the figure denotes a hollow portion that enables deformation of the cut-out notch 51d.

As shown in FIG. 1, the locking member 52 is a so-called stepped bolt provided at the upper portion inner surface in the side portion of the windshield glass 13 and has a bolt head portion 52a, a columnar stepped portion 52b formed on the center axis of the head portion 52a, and a male screw portion 52c formed continuing to the stepped portion 52b coaxially with the stepped portion 52b. The stepped bolt 52 is fastened to the upper portion inner surface of the windshield glass 13 through a bracket 56 formed by bending a steel plate into a hat shape. The bolt head portion 52a is welded to the bracket 56, and the bracket 56 is bonded to the windshield glass 13 so that the male screw portion 52 is oriented toward the opening portion 11a. Here, a height H of the stepped portion 52b is formed slightly higher than a sum b of the thickness of the front outer flange 32b and the thickness of the bracket 56 forming the mounting portion, and an outer diameter of the mounting hole 54a is formed slightly larger than the outer diameter of the stepped portion 52b. The locked member 57 is provided for mounting the glass 13 to the opening portion 11a by locking the locking member made of the stepped bolt 52 by the mounting portion 54. The locked member 57 in this embodiment is a nut capable of being screwed with the male screw portion 52c, and a nut with flange 57, which is a locked member, is shown in the figure. Therefore, the male screw portion 52c of the stepped bolt 52, which is the locking member, is inserted into the mounting hole 54a and then, the stepped portion 52b is inserted into the mounting hole 54a. Next, by screwing the nut 57 with the male screw portion 52c, it is locked by the stepped bolt 52, which is a locking member. Thus, the stepped bolt 52, which is the locking member, is held by the mounting portion 54, and it is constructed so that the upper portion of the windshield glass 13 can be mounted to the upper portion of the opening portion 11a.

When the nut 57 screwed with the male screw portion 52c is brought into contact with the stepped portion 52b, it will not move any more, and the nut 57, which is the locked member, is fastened to the stepped bolt 52, which is the locking member. Here, since the height H of the stepped portion 52b is formed slightly higher than the sum b of the thickness of the front outer flange 32b and the bracket 56 forming the mounting portion 54, the nut 57, which is the locked member, is fastened to the stepped bolt 52, which is the locking member in the state where the stepped bolt 52, which is the locking member, is movable with respect to the mounting portion 54 by an amount equal to a difference obtained by subtracting the thickness of the front outer flange 32b and the thickness of the bracket 56 from the height H of the stepped portion 52b.

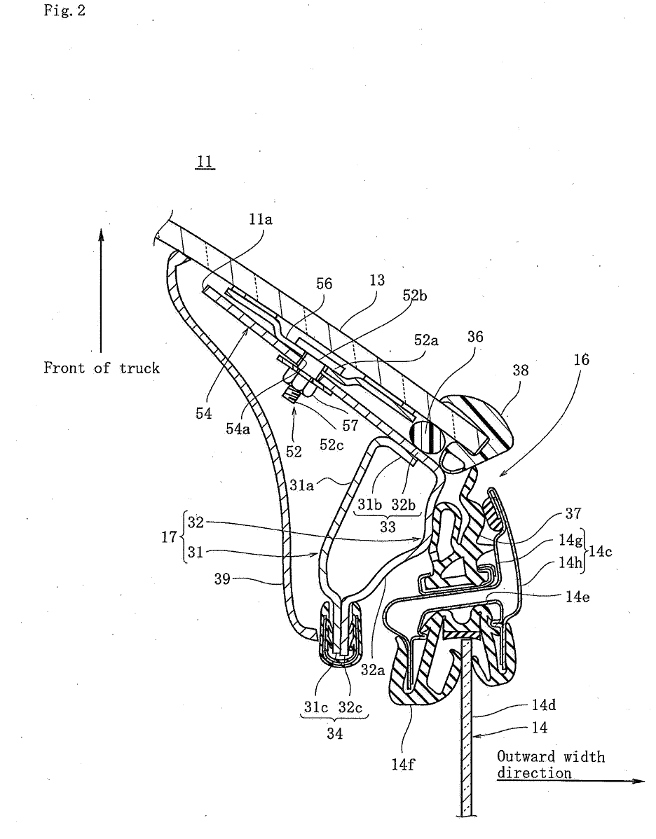

In the glass mounting structure constructed as above, the nut 57 screwed with the male screw portion 52c is brought into contact with the stepped portion 52b and in that state, the nut 57, which is the locked member, is fastened to the stepped bolt 52, which is the locking member. And when the nut 57, which is the locked member, is fastened to the stepped bolt 52, which is the locking member, the stepped bolt 52 is held in the state that it is capable of slight movement with respect to the mounting portion 54. Therefore, as shown in FIG. 2, for example, even if the windshield glass 13 and the mounting portion 54 are not in parallel with each other due to a manufacturing error, inclined and can not be brought into contact with each other and even if the nut 57 is screwed with the bolt 52, the windshield glass 13 to which the bolt 52, which is the locking member, is fastened is not to be brought into close contact with the mounting portion 54 or to be deformed. Therefore, such a situation that the glass 13 is broken when the windshield glass 13 is to be mounted can be effectively avoided.

Also, in the truck 10 in this embodiment, there might be a case where the cab 11 is tilted in the manufacturing process, but even if the cab 11 is tilted before the adhesive 36 for bonding the windshield glass 13 is hardened, the windshield glass 13 is kept in the state that the front opening portion 11a is closed by the locking members 51, 52. Therefore, it becomes possible to lay out an assembling line in which the cab 11 is tilted before the adhesive 36 for bonding the windshield glass 13 is hardened, which can increase degree of freedom in the assembling line process than before.

On the other hand, since the locking members 51, 52 for mounting the windshield glass 13 to the opening portion 11a of the cab 11 is provided at least one of the lower portion inner surface and the upper portion inner surface in the side portion of the windshield glass 13 or both of the lower portion inner surface and the upper portion inner surface in this embodiment, the front outer flange 32b in the side portion of the windshield glass 13 does not have its center portion in the vertical direction protrude toward the center in the width direction of the windshield glass 13. Therefore, by having the pillar inner body 31a substantially in parallel with the visual line of the driver seated in the driver' seat in the truck directed toward the pillar inner body 31a, when the width of the front corner member 16 made of the front pillar 17 and the door frame 14c when seen by the driver seated in the driver's seat of the truck 10 is made as M, the width M of the front corner member 16 seen from the driver can be made narrow. Also, since the front pillar 17 is formed in a cylindrical shape by the pillar inner body 31a, the pillar outer body 32a, the front overlap portion 33, and the rear overlap portion 34, even if the width M of the front corner member 16 is made narrow, predetermined rigidity of the front pillar 17 can be ensured. As a result, while the rigidity of the front pillar 17 is maintained, the width seen from the driver can be made narrow and the width of the front visual field of the driver can be expanded.

Also, by providing the locking members 51, 52 at least at one of the lower portion inner surface and the upper portion inner surface in the side portion of the windshield glass 13, the mounting portions 53, 54 opposed to the locking members 51, 52 are formed at the upper portion and the lower portion of the front pillar 17, so that the formation of the mounting portions 53, 54 makes the pillar shape larger, and the rigidity of the front pillar 17 can be further improved. Also, joining rigidity between the pillar 17 and the other roof members can be improved.

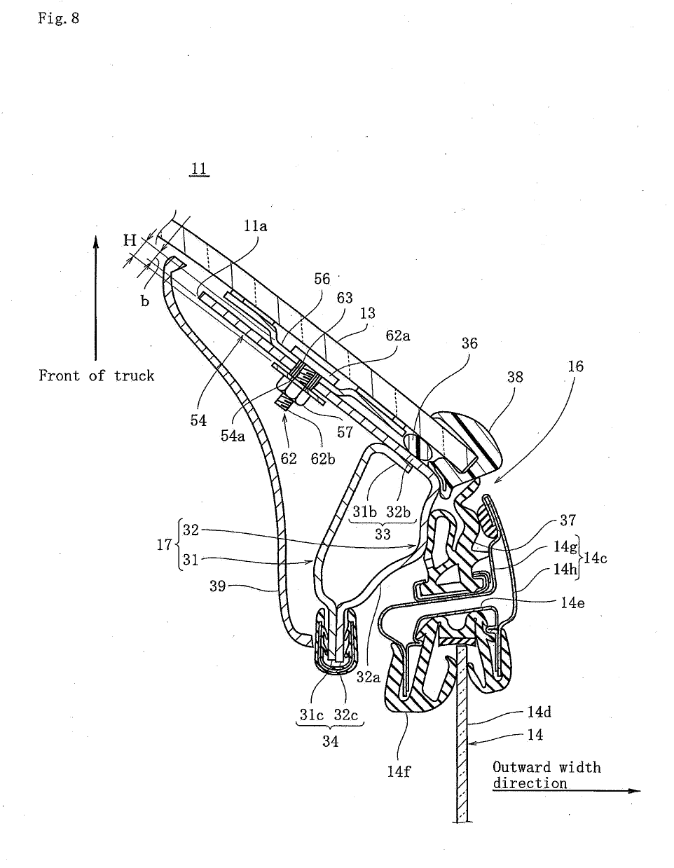

In the above embodiment, it is described that the locking member 52 made of a stepped bolt is the structure in which the locking member 52 is movably fastened to the locked member 57 with respect to the mounting portion 54, but as shown in FIG. 8, when a normal bolt made of a bolt head portion 62a and a full-screw male screw portion 62b is used as a locking member 62, a cylindrical spacer 63 may be fitted into the bolt 62. The cylindrical spacer 63 in this case has an inner diameter slightly larger than the male screw portion 62b, and the height H of the spacer 63 is formed slightly higher than the sum b of the thickness of the front outer flange 32b and the bracket 56 forming the mounting portion 54. And the outer diameter of the mounting hole 54a is formed slightly larger than the outer diameter of the spacer 63. In this construction, the male screw portion 62b of the bolt 62, which is the locking member, is inserted into the mounting hole 54a, and the spacer 63 fitted into the male screw portion 62b is inserted into the mounting hole 54a. And the nut 57 is screwed with the male screw portion 62b and locked by the bolt 62, which is the locking member. The nut 57 screwed with the male screw portion 62b is brought into contact with the spacer 63 and thereby is not moved any more, so that the nut 57, which is the locked member, is held by the bolt 62, which is the locking member. Here, since the height of the spacer 63 is formed slightly higher than the sum b of the thickness of the front outer flange 32b and the bracket 56, the nut 57, which is the locked member, is held by the stepped bolt 62, which is the locking member, in the state that the bolt 62, which is the locking member, is movable with respect to the mounting portion 54.

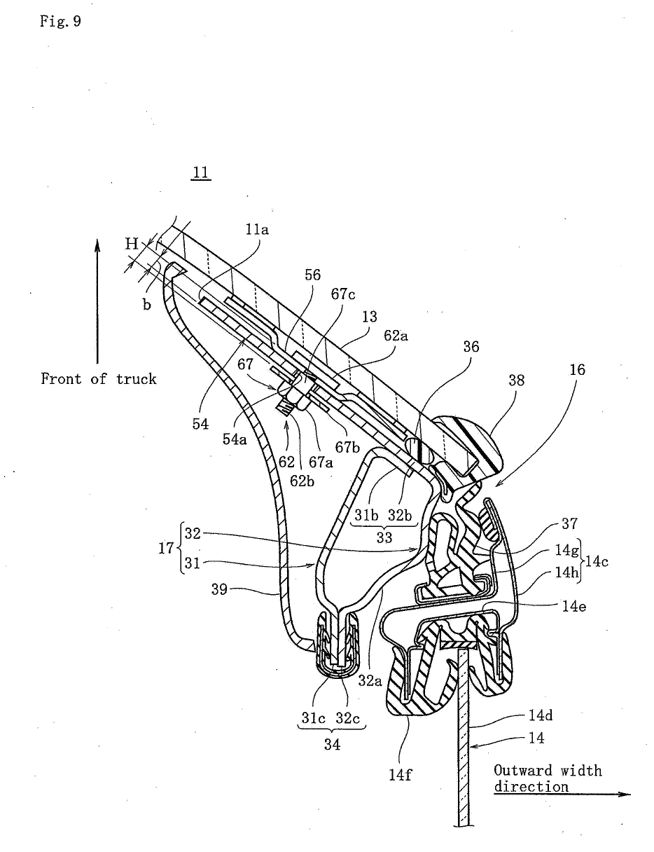

Also, as shown in FIG. 9, when a normal bolt made of the bolt head portion 62a and the full-screw male screw portion 62b is used as the locking member 62, a so-called stepped nut 67 may be used as a locked member. The stepped nut 67 shown in FIG. 9 coaxially comprises a nut body 67a, a disk-state flange portion 67b formed so as to overlap the nut body 67a, and a columnar stepped portion 67c formed continuing to the flange portion, and the male screw is inserted into their center axes for the formation thereof. The height H of the stepped portion 67c in this case is formed slightly higher than the sum b of the thickness of the front outer flange 32b and the bracket 56 forming the mounting portion 54. And the outer diameter of the mounting hole 54a is formed slightly larger than the outer diameter of the stepped portion 67c. In this construction, the male screw portion 62b of the bolt 62, which is the locking member, is inserted into the mounting hole 54a, and the nut 67 is screwed with the male screw portion 62b from the stepped portion 67c side so as to be locked by the bolt 62, which is the locking member. The stepped nut 67, which is the locked member, screwed with the male screw portion 62b has the tip end of the stepped portion 67c brought into contact with the bracket 56 and thereby is not moved any more, so that the stepped nut 67, which is the locking member, is held by the bolt 62, which is the locking member. Here, since the height H of the stepped portion 67c in the stepped nut 67 is formed slightly higher than the sum b of the thickness of the front outer flange 32b and the bracket 56 forming the mounting portion 54, the stepped nut 67, which is the locked member, is held by the stepped bolt 62, which is the locking member, in the state where the bolt 62, which is the locking member, is movable with respect to the mounting portion 54.

In the above embodiment, the case is described that the nuts 57, 67 are screwed with the bolts 52, 62 mounted to the windshield glass 13, but the nuts 57, 67 may be mounted to the windshield glass 13 and the bolts 52, 62 inserted into the mounting hole 54a of the mounting portion 54 may be screwed with the nuts 57, 67.

Also, in the above embodiment, the bolt and the nut are exemplified as the locking member and the locked member, respectively, but the locking member and the locked member may be a dual fastener of male and female.

Moreover, in the above embodiment, a truck is exemplified as a vehicle, but it may be a passenger car or a bus.

Furthermore, in the above embodiment, a vehicle having a driver's seat on the right side, that is, a so-called right-hand-drive car is exemplified as a vehicle, but the present invention may be applied to a vehicle with a driver's seat on the left side, that is, a so-called left-hand-drive car.

1. A glass mounting structure in which a locking member (52, 62) is provided at a glass (13) for closing an opening portion (11a) in a cab (11) comprising, a mounting portion (54) opposite the locking member (52, 62) at the opening portion (11a), and a locked member (57, 67) for mounting the glass (13) to the opening portion (11a) by locking the locking member (52, 62) to the mounting portion (54), wherein
the locked member (57, 67) is held by the locking member (52, 62) so that the locking member (52, 62) is movable with respect to the mounting portion (54).

2. A glass mounting structure comprising a locking member (51, 52) provided at a windshield glass (13) closing an opening portion (11a) at a front portion of a cab (11), a mounting portion (53, 54) opposite the locking member (51, 52) at the opening portion (11a), the windshield glass (13) being mounted to the opening portion (11a) by locking the locking member (51, 52) to the mounting portion (53, 54), wherein
the locking member (51, 52) is provided at least at either a lower portion inner surface or an upper portion inner surface in a side portion of the windshield glass (13).
